(19) United States
(12) Patent Application Publication
(10) Pub. No.: US 2023/0347795 A1
(43) Pub. Date: Nov. 2, 2023

(54) Collapsible Mechanisms In An Environment

(71) Applicant: APPLE INC., Cupertino, CA (US)

(72) Inventors: Philipp J. Wolf, Capistrano Beach, CA (US); Donald R. Monroe, Los Gatos, CA (US); Mikael P. Sedlacek, Carmel Valley, CA (US)

(21) Appl. No.: 18/210,845

(22) Filed: Jun. 16, 2023

Related U.S. Application Data
(63) Continuation of application No. PCT/US2022/012706, filed on Jan. 18, 2022.
(60) Provisional application No. 63/149,726, filed on Feb. 16, 2021.

(51) Int. Cl. B60N 2/02; B60R 11/02; B60N 3/10; B60N 3/00

(52) U.S. Cl. CPC B60N 2/0292; B60R 11/0235; B60N 3/102; B60N 3/001; B60R 2011/0017

(57) ABSTRACT

A collapsible mechanism having a base and a back. A guide moves the base and the back between a support configuration and a table configuration. One or more surfaces of the base or the back form a height-extendible work surface in the table configuration.

### CROSS-REFERENCE TO RELATED APPLICATION(S)

This application is a continuation of International Patent Application No. PCT/US2022/12706, filed on Jan. 18, 2022, which claims the benefit of U.S. Provisional Patent Application No. 63/149,726, filed on Feb. 16, 2021, the content of which is hereby incorporated by reference in its entirety for all purposes.

### TECHNICAL FIELD

This disclosure relates generally to collapsible mechanisms and specifically to work surfaces and displays associated with collapsible mechanisms.

### BACKGROUND

Design innovations are possible in terms of interior features within an environment such as a vehicle cabin. For example, seating systems can include seats that can be arranged into configurations consistent with the vehicle cabin serving as a living room or a mobile office. However, furnishings to support functionality of the vehicle cabin as the living room or the mobile office, such as work surfaces, displays, ottomans, etc., are absent, limited in use, or bulky in terms of requiring packaging space when not in use. In the absence of adequate furnishings or sufficient space, occupants may be unable to effectively work or relax during a vehicle journey. New approaches to collapsible mechanisms are thus desired.

### SUMMARY

A first aspect of the disclosure is a seating system for a vehicle that includes a seat with a base, a back, and a headrest. Surfaces of one or more of the base, the back, or the headrest form a work surface accessible to an occupant in another seat of the vehicle when the seat is positioned in a table configuration. In some examples, the one or more surfaces that include or form the work surface are referred to as interaction surfaces. The work surface extends at a height in a Z direction that is adjustable for access by the occupant in the other seat when the seat is positioned in the table configuration. That is, the work surface is height-extendible.

In the first aspect, the seating system can further comprise a seat guide configured to guide movement of one or more of the base, the back, or the headrest from the table configuration to a seating configuration. The seating surfaces of the base, the back, and the headrest are configured to support another occupant in the seat when the seat is positioned in a seating configuration. The seating surfaces of the base, the back, and the headrest can oppose respective interaction surfaces of the base, the back, and the headrest when the seat is positioned in the seating configuration. The interaction surface that forms the work surface can be movable in respect to its respective seating surface. The seating surface of the back can form an interior surface of a vehicle cabin of the vehicle when the seat is positioned in the table configuration. The interaction surfaces of the back and the headrest can form the work surface when the seat is positioned in the table configuration. The interaction surface of the base can form an interior surface of a vehicle cabin of the vehicle when the seat is positioned in the table configuration. The interaction surface of the base can form the work surface when the seat is positioned in the table configuration. The first aspect may include any combination of the features described in this paragraph.

A second aspect of the disclosed embodiments is a seating system for a vehicle that includes a seat with a base, a back, and a headrest. An interaction surface of the base, the back, or the headrest includes a display configured for viewing by an occupant in another seat in the vehicle when the seat is positioned in a display configuration. Seating surfaces of one or more of the base, the back, and the headrest are inaccessible for seating when the seat is positioned in in the display configuration.

In the second aspect, the seating system can further comprise a seat guide configured to guide movement of or more of the base, the back, or the headrest from the display configuration to a seating configuration. The respective seating and interaction surfaces of the base, the back, and the headrest can be opposed surfaces in the seating configuration. The display is sandwiched between the respective seating and interaction surfaces when the seat is positioned in the seating configuration. Movement between the display configuration and the seating configuration using the seat guide occurs responsive to receiving a command, from a controller, based on an input from the occupant in the other seat or based on an input from a sensor of the vehicle. The seating surfaces of the base, the back, and the headrest can be configured to support another occupant in the seat when the seat is positioned in the seating configuration. The interaction surface of one of the base, the back, or the headrest that does not include the display can form a work surface accessible to the occupant in the other seat in the vehicle when the seat is positioned in the display configuration. The work surface includes a cupholder, a shelf, a ledge, or a support accessible the occupant in the other seat in the vehicle. The second aspect may include any combination of the features described in this paragraph.

A third aspect of the disclosed embodiments is a seating system for a vehicle that includes a seat with a base and a back. An interaction surface of the base or the back includes a display configured for viewing by an occupant in another seat in the vehicle when the seat is positioned in a display configuration. One or more of the interaction surfaces of the base or the back forms a work surface accessible to the occupant in the other seat when the seat is positioned in the display configuration. The seating system also includes a seat guide configured to guide movement of one or more of the interaction surfaces of the base or the back from the display configuration to a seating configuration. Seating surfaces of the base and the back are configured to support another occupant in the seat when the seat is positioned in the seating configuration.

In the third aspect, the seating surfaces of the base and the back can be inaccessible for seating when the seat is positioned in in the display configuration. The interaction surface that includes the display can extend in a Z direction to a height that is adjustable for access by the occupant in the other seat when the seat is positioned in the display configuration. The seating surfaces of the base and the back can oppose respective interaction surfaces of the base and the back when the seat is positioned in the seating configuration. The interaction surface that includes the display can be movable in respect to its respective seating surface. The seating surface of the base can form an ottoman configured to receive feet of the occupant in the other seat when the seat is positioned in the display configuration. The seating surface of the base can form an interior surface of a vehicle cabin of the vehicle when the seat is positioned in the display configuration. The interaction surface of the back of the seat can include the display when the seat is positioned in the display configuration. The display is stored between the interaction surface and the seating surface of the back of the seat when the seat is positioned in the seating configuration. The seat can include a headrest, and an interaction surface of the headrest forms a work surface that is accessible to the occupant in the other seat when the seat is positioned in the display configuration. The seat can include a headrest, and an interaction surface of the headrest includes the display when the seat is positioned in the display configuration. The third aspect may include any combination of the features described in this paragraph.

### BRIEF DESCRIPTION OF THE DRAWINGS

FIG. 1 is a schematic side view illustration of a vehicle cabin with a seating system.

FIG. 2 is schematic side view illustration of the vehicle cabin of FIG. 1 with the seating system in another configuration.

FIG. 3 is a schematic top view illustration of the vehicle cabin of FIG. 1.

FIG. 4 is a schematic top view illustration of the vehicle cabin of FIG. 2.

FIG. 5 is a schematic side view illustration of a seat in a table configuration.

FIG. 6 is a schematic side view illustration of a seat in another table configuration.

FIG. 7 is a schematic side view illustration of a seat in another table configuration.

FIG. 8 is a schematic side view illustration of a seat in another table configuration.

FIG. 9 is a schematic side view illustration of a seat in a display configuration.

FIG. 10 is a schematic side view illustration of a seat in another display configuration.

FIG. 11 is a schematic side view illustration of a seat in another display configuration.

FIG. 12 is a schematic side view illustration of a seat in another display configuration.

FIG. 13 is a schematic top view illustration of a work surface of a seat.

FIG. 14 is a schematic front view illustration of a work surface of a seat.

FIG. 15 is a block diagram of a seating system.

FIG. 16 is an illustration of a hardware configuration for a controller.

### DETAILED DESCRIPTION

Collapsible mechanisms such as collapsible seats are described for use in an environment such as a vehicle cabin. A seating system can include one or more seats that can be positioned in multiple configurations, such as generally open in a seating configuration, collapsed in a table configuration, and partially collapsed in a display configuration. A seat can include a base, a back, and an optional headrest. The base, the back, and the optional headrest can have seating surfaces and other surfaces, such as opposed surfaces. The seating surfaces can be configured to support an occupant when the seat is in a seating configuration. The other surfaces, for example, that oppose or face away from respective seating surfaces of the base, the back, and/or the optional headrest, can be configured to serve as work surfaces, include displays, or both when the seat is fully or partially collapsed in a table configuration or a display configuration.

Components of the seat that serve as work surfaces and displays can be conveniently positioned in respect to an occupant in another seat in the vehicle cabin. For example, a surface that includes or serves as a work surface of the seat can be moved to a desired height using a seat guide, that is, the work surface can be height-extendible. In another example, several components of the seat can be used together to form a work surface, such as two or more surfaces. In another example, a single component of the seat (e.g., a surface of the headrest) can be extended in size (width or length) to provide a desired area for work, that is, a work surface, when other components are collapsed or folded together. In another example, a display can be stored between a seating surface of one portion of the seat (such as the base or the back) and a surface of another portion of the seat (such as the back or the base) when the seat is in a seating configuration but extended for accessibility to the occupant in the other seat when the seat is in a display configuration.

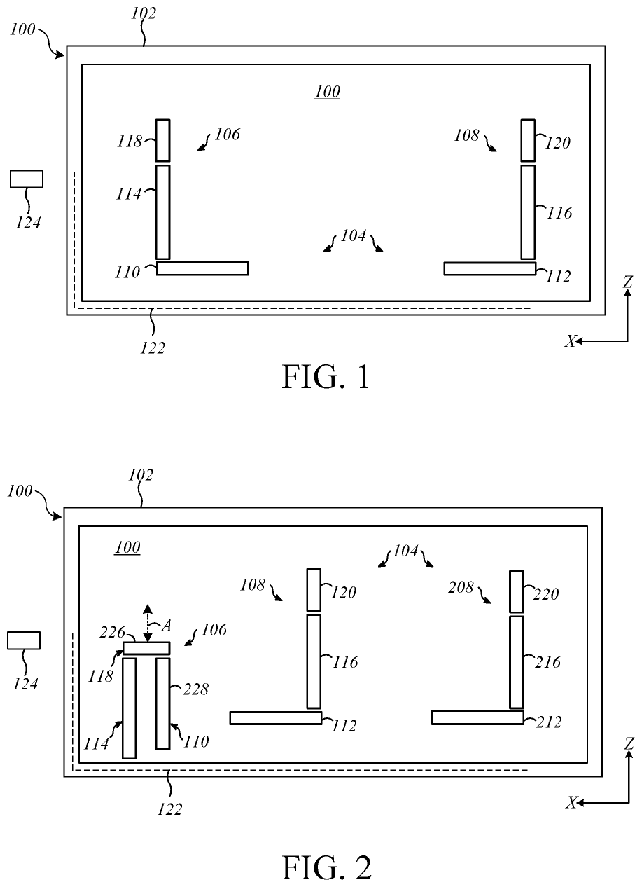

FIG. 1 is a schematic side view illustration of a vehicle cabin 100. The vehicle cabin 100 is defined within or is otherwise interior to a body structure 102 and can be described in reference to a longitudinal or X direction (e.g., fore-aft) and an elevational or Z direction (e.g., up-down) as shown in the side view illustrations. The body structure 102 may include pillars, a frame, roof rails, body panels, interior panels, trim panels, and movable panels (e.g., doors, tailgate, hood, trunk lid, etc., not shown) that are connected to other portions of the body structure 102 by mechanisms such as hinges or tracks.

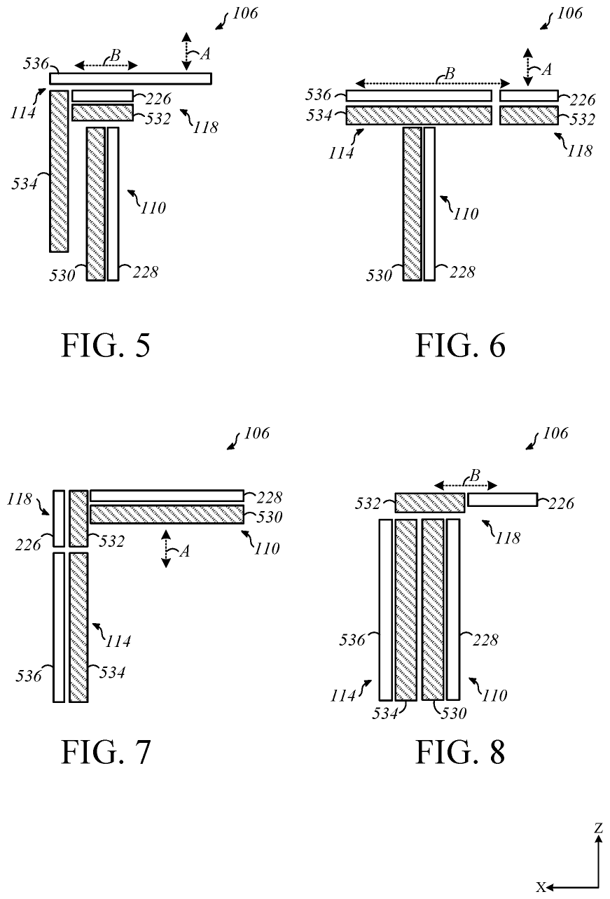

The vehicle cabin 100 includes a seating system 104 with seats 106, 108 facing each other as shown, for example, in an opposed seating configuration with the seats 106, 108 positioned in a manner that seating surfaces (not shown, see FIGS. 5 to 12) of the seats 106, 108 can support at least two occupants (not shown) in the vehicle cabin 100. The seat 106 is located at a left or front of the vehicle cabin 100 and may be rear-facing when the vehicle cabin 100 is moving left or forward in the X direction. The seat 108 is located at a rear of the vehicle cabin 100 and may be front-facing when the vehicle cabin 100 is moving left or forward in the X direction. Thus, the opposed seating configuration shown can support at least two different occupants, one in each of the seats 106, 108, and the occupants will face each other in the vehicle cabin 100.

Each of the seats 106, 108, has a base 110, 112, a back 114, 116, and a headrest 118, 120. The headrests 118, 120 may be absent in some embodiments (not shown). The backs 114, 116 are shown as extending upward from the bases 110, 112 and may be movable in respect to the bases 110, 112. The headrests 118, 120 are shown as extending upward from the backs 114, 116 and may be movable in respect to the backs 114, 116 and the bases 110, 112. The seating system 104 can also include restraints (not shown) for use in securing occupants to the seats 106, 108. The seating system 104 can include additional components (not shown) such as sensors, airbags, armrests, etc. to provide passenger safety and comfort.

The bases 110, 112, the backs 114, 116, and the headrests 118, 120 may include seating surfaces (see FIGS. 5-12) that enclose occupant support structures such as frames, springs, suspension members, foam or rubber cushions, and/or other structures (not shown) suitable for use in supporting occupants as secured in the seats 106, 108 in the seating configuration. The seats 106, 108 are positioned in a living-room-type, opposed seating configuration in FIG. 1. The seating surfaces and/or the occupant support structures (see FIGS. 5-12) can be fixed in position or configured to translate, rotate, or otherwise move in respect to other structures that form the bases 110, 112, the backs 114, 116, and the headrests 118, 120 of the seats 106, 108.

The seats 106, 108 are movable in respect to and optionally under control of a seat guide 122. In this example, the seat guide 122 is shown using dotted lines extending in both the X direction and the Z direction within the vehicle cabin 100. The dotted lines of the seat guide 122 represent a travel envelope for the seats 106, 108 suitable for repositioning portions (or entireties) of the seats 106, 108 in the vehicle cabin 100. The seat guide 122 can be configured to support fore-aft movement, up-down movement, and side-to-side movement of portions (or entireties) of the seats 106, 108 to allow for various configurations of the seating system 104 within the vehicle cabin 100. The seat guide 122 can be configured to control or enable movement of the bases 110, 112 (and optionally, the backs 114, 116 and the headrests 118, 120) of the seats 106, 108 using hinges, linkages, pivots, rails, guides, slots, tracks, motors, actuators, electromagnets, or any other suitable mechanisms (not shown). The seat guide 122 can be at least partially integrated as a component of the seats 106, 108 and/or a separate part of the seating system 104 or the vehicle cabin 100.

The seating system 104 can include or be in communication with a controller 124. For example, the controller 124 can be configured to send commands that prohibit, allow, or otherwise control movement of the bases 110, 112, the backs 114, 116, the headrests 118, 120, or entireties of the seats 106, 108 in the seating system 104 in respect to the seat guide 122 or in respect to other portions of the vehicle cabin 100. The controller 124 can be configured to receive inputs from occupants or to receive signals from sensors associated with the vehicle cabin 100 (not shown) that include information indicative of orientation or position of the bases 110, 112, the backs 114, 116, the headrests 118, 120, the seats 106, 108, or occupants in respect to the seats 106, 108 in the vehicle cabin 100. The controller 124 can be configured to send commands to the seat guide 122 or to the seats 106, 108 in order to support movement of various components in the seating system 104 to achieve various configurations and provide additional utility and comfort to the occupant(s) in the vehicle cabin 100. For example, the seat guide 122 is used for reconfiguring the seats 106, 108 between a seating configuration (as shown in FIG. 1), a table configuration, or a display configuration as described herein.

The types of sensors (not shown) employed to support the seating system 104 can be varied and can communicate information to the controller 124. For example, the sensors can include sensors configured to capture information from an external environment outside of the vehicle cabin 100. External-sensing sensors can includes technologies such as radar, LIDAR, imaging, infrared, or other technologies configured to detect potential vehicle occupants and provide information to the controller 124 to support changes to a configuration of the seating system 104 prior to the potential vehicle occupants entering the vehicle cabin 100. The sensors can also include sensors internal to the vehicle cabin 100 such as weight sensors, buckle switch sensors, seat position sensors, imaging sensors, etc. that can provide information to the controller 124 to support safely repositioning any combination of the bases 110, 112, the backs 114, 116, the headrests 118, 120, or the seats 106, 108 in the seating system 104 consistent with various configurations.

FIG. 2 is schematic side view illustration of the vehicle cabin 100 of FIG. 1 with the seating system 104 in a different configuration. The seat 106 has moved from the seating configuration shown in FIG. 1 to a table configuration shown in FIG. 2, and the base 110, the back 114, and the headrest 118 of the seat 106 are folded or collapsed together, for example, by rotating or translating in respect to the seat guide 122. Seating surfaces (not shown, see FIGS. 5-12) of the base 110, the back 114, and the headrest 118 are thus inaccessible for seating when the seat 106 is positioned in in the table configuration shown. In contrast, the seating surfaces of the base 110, the back 114, and the headrest 118 are configured to support one or more occupants when the seat 106 is positioned in the seating configuration of FIG. 1.

In FIG. 2, the seat 108 remains in a seating configuration but has moved forward in the X direction in the vehicle cabin 100 toward the seat 106 in the table configuration, such as by use of the seat guide 122. The forward movement of the seat 108 allows an occupant (not shown) supported by the seat 108 to more easily access a surface 226 of the headrest 118 of the seat 106 in the table configuration shown. For example, an occupant in the seat 108 can use the surface 226 of the headrest 118 as a work surface while an opposing surface that faces away from the surface 226 (e.g., the seating surface) of the headrest 118 is inaccessible based on the collapsed position of the seat 106 in the table configuration. The surface 226 of the headrest 118 of the seat 106 can include a generally planar or flat portion formed from material such as polymer, wood, or composite that can serve, for example, as a table or shelf that extends horizontally in the X and Y directions when the seat 106 is in the table configuration. The term horizontally is used to describe a direction within several degrees of horizontal or level to reduce a likelihood of any objects rolling, slipping, or sliding from the work surface, table, or shelf.

For example, the surface 226 of the headrest 118 may be generally planar, having a smooth, flat portion that can support objects or belongings such as a computer, a mobile device, a book, homework materials, toys, etc. for access and use by an occupant in the seat 108 when the seat 106 is in the table configuration shown in FIG. 2. A height in the Z direction of the surface 226 of the headrest 118 can be adjustable as shown by the dotted-line arrow A to support access to the surface 226 at a comfortable position for the occupant in the seat 108 when the seat 106 is positioned in the table configuration shown. Adjustments in height in the Z direction can be effected using hinges, pivots, rails, guides, linkages, supports, the seat guide 122, or other positioning mechanisms (not shown) such as by modifying a position of the base 110, the back 114, and the headrest 118 or by modifying a position of the headrest 118 or the surface 226 of the headrest 118 alone.

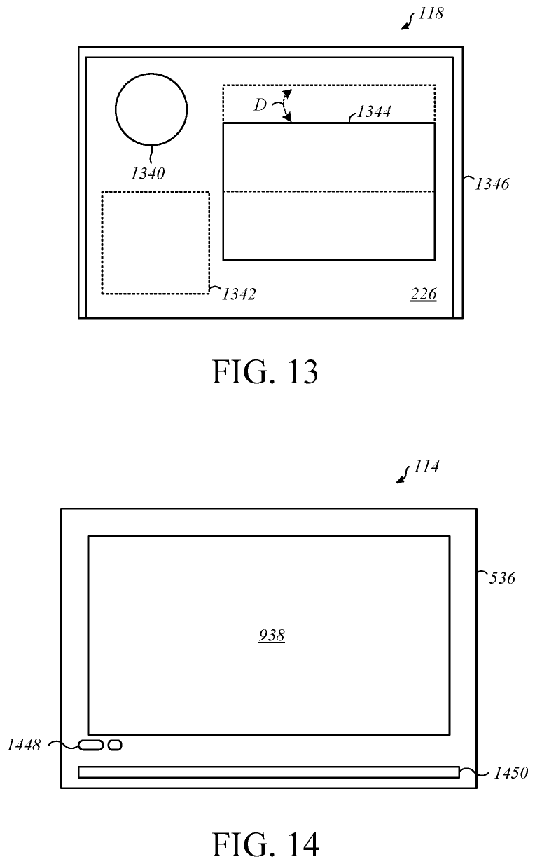

The surface 226 can be formed by smooth, flat, solid materials sufficient to support objects or belongings accessible to the occupant positioned in the seat 108. In some embodiments, a durable portion of the surface 226 can be surrounded or supported by softer, traditional seating materials such as leather or foam. In the example in FIG. 2, the surface 226 is a rear or back surface of the headrest 118 that is fixed in position and opposes or faces away from a front, occupant-supporting portion of the headrest 118 referred to as the seating surface (not shown, see FIGS. 5-12) of the headrest 118. That is, the surface 226 can face an opposite direction from or form an opposite end or side of the headrest 118 as compared to the seating surface of the headrest 118. The surface 226 can also be movable in respect to the seating surface of the headrest 118, such as using guides, rails, or stops, to change a size or location of the work surface formed by the surface 226 of the headrest 118 when the seat 106 is positioned in the table configuration shown in FIG. 2. The surface 226 can include connectivity features (e.g., charging access) and shaped features such as one or more cupholders, shelves, movable supports, or ledges (not shown, see FIG. 13) designed to assist in retaining objects or belongings of the occupant on the work surface of the surface 226 while the vehicle cabin 100 in is motion.

With the seat 106 in the table configuration as shown in FIG. 2, a surface 228 of the base 110 of the seat 106 forms an interior surface of the vehicle cabin 100. The base 110 of the seat 106 also serves as a support for the headrest 118 that includes the surface 226 serving as a work surface. In other words, when the base 110, the back 114, and the headrest 118 are folded or collapsed together as shown, the seating surfaces (not shown, see FIGS. 5-12) of the base 110 and the back 114 can be sandwiched between rear or back surfaces of the base 110 and the back 114, narrowed in width in the X direction, and moved toward a left or front side of the vehicle cabin 100 such that the rear or back surface of the base 110 of the seat 106 extends as the surface 228 in a generally vertical manner in the Y and Z directions. The term vertical is used to describe a direction within several degrees of vertical and can be consistent with a direction that extends normal with respect to a bottom side of the vehicle cabin 100. In this way, the surface 228 of the base 100 serves as both a generally planar interior wall of the vehicle cabin 100 and as a kick-resistant surface that can handle being kicked or scuffed by the occupant (not shown) in the seat 108. The seating surfaces of the seat 106 can be inaccessible for seating when the seat 106 is positioned in the table configuration. Portions of or an entirety of the surface 228 can be formed by smooth, flat or planar, solid materials, such as polymer, wood, or composite, sufficient to weather scuffs and kicks and to protect the seating surfaces from wear when the seat 106 is in the table configuration shown in FIG. 2.

Another seat 208 is shown as positioned at a rear of the vehicle cabin 100 in FIG. 2. The seat 208 may also be front-facing when the vehicle cabin 100 is moving left or forward in the X direction. The seat 208 may not be visible in FIG. 1 based on the seat 108 being aligned with the seat 208 in side view in FIG. 1. In other words, the seating system 104 supports side-by-side occupants in the seats 108, 208 in FIG. 1 whereas occupants in the seats 108, 208 in FIG. 2 are spaced apart from each other in the X direction, with the seat 108 nearer to a front or left of the vehicle cabin 100 and the seat 208 nearer to a back or right of the vehicle cabin 100. The configuration of the seats 106, 108, 208 in FIG. 2 allows an occupant (not shown) supported by the seat 108 to access the surface 226 of the headrest 118 of the seat 106 in the table configuration while another occupant (not shown) supported by the seat 208 remains at a rear of the vehicle cabin 100, so as to recline, to be socially distanced from the occupant supported by the seat 108, or to relax.

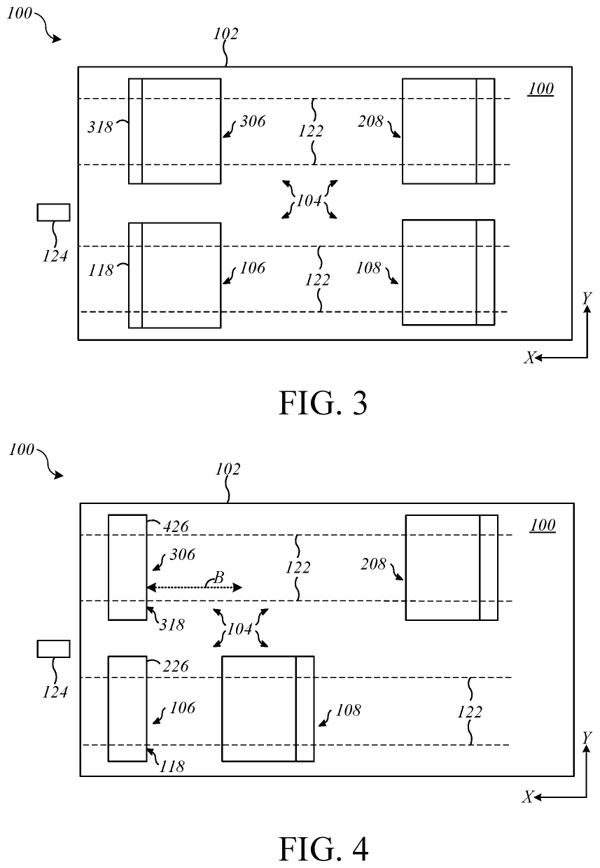

FIG. 3 is a schematic top view illustration of the vehicle cabin 100 of FIGS. 1 and 2 with the longitudinal or X direction (e.g., fore-aft) and the lateral or Y direction (e.g., left-right) shown in the top view illustration. The seating system 104 is shown as including four seats 106, 108, 208, 306, with the seats 106, 108 facing each other and the seats 208, 306 facing each other. The seats 106, 306 are located at a left or front of the vehicle cabin 100 and may be rear-facing when the vehicle cabin 100 is moving left or forward in the X direction. The seats 108, 308 are located at a rear of the vehicle cabin 100 and may be front-facing when the vehicle cabin 100 is moving left or forward in the X direction. Though shown as separate, the seats 106, 306 may form a unitary bench-style seat. Though shown as separate, the seats 108, 208 may also form a unitary bench-style seat, for example, sufficient to support three occupants (not shown).

The opposed seating configuration shown in FIG. 3 can support four different occupants, one in each of the seats 106, 108, 208, 306. Thus, pairs of occupants can face each other in the vehicle cabin 100 in the opposed seating configuration. The seats 106, 108, 208, 306 can be movable, together or independently, in respect to the seat guide 122 and based on commands, for example, from the controller 124. The seat guide 122 is shown as four dotted lines extending in the X direction across the vehicle cabin 100 indicative of fore-aft movement, but lateral, left-right movement in the Y direction and vertical, up-down movement in the Z direction (see, e.g., FIG. 2) of various components of the seats 106, 108, 208, 306 is also possible. The headrest 118 of the seat 106 and a headrest 318 of the seat 306 are shown in the top view illustration of FIG. 3 for comparison to the table configuration of FIG. 4.

FIG. 4 is a schematic top view illustration of the vehicle cabin 100 of FIG. 2. The seats 106, 306 have moved from the seating configuration shown in FIGS. 1 and 3 to the table configuration shown in FIG. 2. Only the headrests 118, 318 of the seats 106, 306 are visible in the top view of FIG. 4 as the seats 106, 306 are folded or collapsed together for use of the headrests 118, 318 as work surfaces by one or more occupants (not shown) or for storage purposes to allow for additional open space in the vehicle cabin 100. The seat 108 remains in a seating configuration but has moved forward in the X direction in the vehicle cabin 100 toward the seat 106 in the table configuration. The seat 208 remains both in a seating configuration and at a location proximate to a rear or a back of the vehicle cabin 100.

The forward movement of the seat 108 allows an occupant (not shown) supported by the seat 108 to more easily access the surface 226 of the headrest 118 of the seat 106, and, if useful, a surface 426 of the headrest 318 of the seat 306 in the table configuration. Though shown as aligned in the Y-direction, the seats 106, 306 and corresponding surfaces 226, 426 can be positioned in respect to the seat 108 such that the surface 226 serves as a forward (in the X direction) work surface and the surface 426 serves as a side (adjacent in the Y direction) work surface for an occupant (not shown) supported by the seat 108. That is, the seat 306 can be controlled to move rearward toward the seat 208, along or effected by the seat guide 122, until adjacent to a side of the seat 108 as shown by the dotted-line arrow B. Positioning both of the surfaces 226, 426 as work surfaces proximate to the seat 106 allows for more objects or belongings to be supported for and accessible to an occupant (not shown) in the seat 108 than collapsing only the seat 106.

In another example (not shown), the seat 208 can be positioned closer to the seat 306, based on moving either or both of the seats 208, 306 horizontally in the X direction along or under effect of the seat guide 122, such that the surface 426 of the headrest 318 of the seat 306 is configured to serve as a work surface for an occupant (not shown) in the seat 208. In this example, two occupants (not shown) supported by the seats 108, 208 have access to discrete work surfaces in the form of the surfaces 226, 426 of the headrests 118, 318 of the seats 106, 306. The seats 108, 208 and the corresponding surfaces 226, 426 can also be spaced apart from each other in the X direction to allow some social distance or some privacy between the working occupants.

FIGS. 5 to 8 show a variety of table configurations achievable in the seating system 104 using the seat 106 of FIGS. 1 to 4 to describe the examples. Though four examples of table configurations are given, additional table configurations using the seat 106 or the seats 108, 208, 306 are also possible.

FIG. 5 is a schematic side view illustration of the seat 106 of FIGS. 1 to 4 in another table configuration. Additional details of the seat 106 are numbered as compared to FIGS. 1 to 4 in order to support a more detailed description of positioning of various components that form the seat 106. For example, a seating surface 530 is shown in hatched line, and together with the corresponding surface 228, forms the base 110 of the seat. The seating surface 530 and the surface 228 are opposed surfaces of the base 110 that face away from each other as shown. A seating surface 532 is shown in hatched line, and together with the corresponding surface 226, forms the headrest 118 of the seat 106. The seating surface 532 and the surface 226 are opposed surfaces of the headrest 118 that face away from each other as shown. A seating surface 534 is shown in hatched line, and together with a corresponding surface 536, forms the back 114 of the seat 106. The seating surface 534 and the surface 536 extend in a generally perpendicular manner in the table configuration shown.

The seat guide 122 and the controller 124 of FIGS. 1 to 4 can be used to move the seating surfaces 530, 532, 534 and the surfaces 226, 228, 536 between a seating configuration (such as the seating configuration of the seat 106 shown in FIGS. 1 and 3) and the table configuration shown in FIG. 5. Movement between configurations can occur, for example, in response to an input from an occupant in another seat (e.g., the seat 108 of FIGS. 1 to 4) or based on an input from a sensor of the vehicle (not shown).

In the table configuration of FIG. 5, the surface 536 of the back 114 of the seat 106 forms a work surface accessible to an occupant in another seat (e.g., an occupant using the seat 108 shown in FIGS. 1 to 4). The seating surface 534 of the back 114 of the seat 106 extends vertically in the Y and Z directions in a generally planar manner, as does the base 110 of the seat 106. The headrest 118 extends horizontally in the X and Y directions underneath the surface 536 of the back 114 in a corresponding planar manner such that the headrest 118 and the surface 536 are generally parallel. The seating surface 534, the base 110, and the headrest 118 all support the surface 536 of the back 114 of the seat 106 in serving as a work surface, for example, in a cantilevered fashion as shown. The surface 536 of the back 114 of the seat 106 can be larger than the surface 226 of the headrest 118 of the seat 106, thus providing additional work area to an occupant in another seat when the seat 106 is in the table configuration shown in FIG. 5.

The surface 536 of the back 114 can also be movable in respect to the seating surface 534 of the back 114 and in respect to the surface 226 of the headrest 118, for example, in order to change a size or position of the work surface formed by the surface 536. The surface 536 can be adjustable in height in a Z direction as shown by the dotted-line arrow A and adjustable in length or position in an X direction as shown by the dotted-line arrow B. Positional changes can be effected using hinges, pivots, rails, guides, linkages, supports, the seat guide 122, or other positioning mechanisms (not shown) based on inputs received by the controller 124, commands sent to the seat guide 122 (or other positioning mechanisms), or based on inputs received from an occupant. The surface 536 can include connectivity features (e.g., charging access) and shaped features such as one or more cupholders, shelves, movable supports, or ledges (not shown) designed to assist in retaining objects or belongings on the surface 536 while the vehicle is in motion.

In the table configuration of FIG. 5, the surface 228 of the base 110 of the seat 106 can serve as both an interior wall of the vehicle cabin 100 and as protective surface that can weather being kicked or scuffed by an occupant (not shown) of the vehicle using surface 536 of the seat 106 as a work surface. Portions or entireties of the surfaces 228, 536 of the base 110 and the back 114 can be formed by smooth, flat or planar, solid materials, such as polymer, wood, or composite, sufficient to weather scuffs, scratches, dents, or kicks. The surfaces 228, 536 of the base 110 and the back 114 can also protect the seating surfaces 530, 532, 534 of the seat 106 from damage when the seat 106 is in the table configuration shown.

FIG. 6 is a schematic side view illustration of the seat 106 of FIGS. 1 to 5 in another table configuration. The seat guide 122 and the controller 124 of FIGS. 1 to 4 can be used to move the seating surfaces 530, 532, 534 and the surfaces 226, 228, 536 of the seat 106 between a seating configuration and the table configuration shown, for example, in response to an input from an occupant in another seat (e.g., the seat 108 of FIGS. 1 to 4) or based on an input from a sensor of the vehicle (not shown). In this example, the seating surface 530 opposes the surface 228 of the base, the seating surface 532 opposes the surface 226 of the headrest 118, and the seating surface 534 opposes the surface 536 of the back 114 of the seat 106.

In the table configuration of FIG. 6, the surface 226 of the headrest 118 and the surface 536 of the back 114 of the seat 106 together form a work surface accessible to an occupant in another seat (e.g., an occupant using the seat 108 shown in FIGS. 1 to 4). The base 110 of the seat 106 extends vertically in the Y and Z directions and supports the back 114 and the headrest 118 in a cantilevered fashion. The back 114 and the headrest 118 extend horizontally in the X and Y directions to form the generally planar work surface. The combination of the surface 226 of the headrest 118 and the surface 536 of the back 114 of the seat 106 can form a large work surface, one that extends further left or forward in the X direction within the vehicle cabin 100 of FIGS. 1 to 4 than the work surfaces shown in FIGS. 4 and 5.

The surfaces 226, 536 of the headrest 118 and the back 114 can be adjustable in height in a Z direction as shown by the dotted-line arrow A and adjustable in length or position in an X direction as shown by the dotted-line arrow B. Positional changes can be effected using hinges, pivots, rails, guides, linkages, supports, the seat guide 122, or other positioning mechanisms (not shown) based on inputs received by the controller 124, commands sent to the seat guide 122 (or other positioning mechanisms), or based on inputs received from an occupant. The surfaces 226, 536 can include connectivity features (e.g., charging access) and shaped features such as one or more cupholders, shelves, movable supports, or ledges (not shown) designed to assist in retaining objects or belongings on the surface 536 while the vehicle is in motion.

In the table configuration of FIG. 6, the surface 228 of the base 110 of the seat 106 can serve as both an interior wall of the vehicle cabin 100 and as protective surface that can weather being kicked or scuffed by an occupant (not shown) of the vehicle using the surfaces 226, 536 of the seat 106 as a work surface. Portions or entireties of the surfaces 226, 228, 536 of the base 110, the back 114, and the headrest 118 can be formed by smooth, flat or planar, solid materials, such as polymer, wood, or composite, sufficient to weather scuffs, scratches, dents, or kicks. The surface 228 of the base 110 can also protect the seating surface 530 of the base 110 from damage when the seat 106 is in the table configuration shown.

FIG. 7 is a schematic side view illustration of the seat 106 of FIGS. 1 to 6 in another table configuration. The seat guide 122 and the controller 124 of FIGS. 1 to 4 can be used to move the seating surfaces 530, 532, 534 and the surfaces 226, 228, 536 of the seat 106 between a seating configuration and the table configuration shown, for example, in response to an input from an occupant in another seat (e.g., the seat 108 of FIGS. 1 to 4) or based on an input from a sensor of the vehicle (not shown). In this example, the seating surface 530 opposes the surface 228 of the base 110, the seating surface 532 opposes the surface 226 of the headrest 118, and the seating surface 534 opposes the surface 536 of the back 114 of the seat 106.

In the table configuration of FIG. 7, the surface 228 of the base 110 forms a work surface accessible to an occupant in another seat (e.g., an occupant supported in the seat 108 shown in FIGS. 1 to 4). The back 114 and the headrest 118 of the seat 106 extend vertically in the Y and Z directions and support the base 110 in a cantilevered fashion. The base 110 extends horizontally in the X and Y directions to form the generally planar work surface. The surface 228 of the base 110 of the seat 106 can provide a large working area while limiting motion of the back 114 and the headrest 118 of the seat 106 in the X direction needed to achieve the table configuration shown. For example, the table configurations of FIGS. 5 and 6 require portions of the back 114 and the headrest 118 to fold or turn from top ends downward where the table configuration of FIG. 7 requires the base 110 to fold or turn from a bottom end upward.

The base 110 of the seat in the table configuration of FIG. 7 can be adjustable in height in a Z direction as shown by the dotted-line arrow A to achieve positioning. Positional changes can be effected using hinges, pivots, rails, guides, linkages, supports, the seat guide 122, or other positioning mechanisms (not shown) based on inputs received by the controller 124, commands sent to the seat guide 122 (or other positioning mechanisms), or based on inputs received from an occupant. The surface 228 of the base 110 can include connectivity features (e.g., charging access) and shaped features such as one or more cupholders, shelves, movable supports, or ledges (not shown) designed to assist in retaining objects or belongings on the surface 228 while the vehicle is in motion. The seating surface 534 of the back 114 of the seat 106 can serve as an interior wall of a vehicle cabin, blocking access to other portions of the vehicle, for example, such that objects in the vehicle cabin 100 are not able to enter an interior of the vehicle or storage areas of the vehicle (not shown). The surface 228 of the base 110 can be formed by smooth, flat or planar, solid materials suitable to provide a working area to an occupant in the vehicle.

FIG. 8 is a schematic side view illustration of the seat 106 of FIGS. 1 to 4 in another table configuration. The seat guide 122 and the controller 124 of FIGS. 1 to 4 can be used to move the seating surfaces 530, 532, 534 and the surfaces 226, 228, 536 of the seat 106 between a seating configuration and the table configuration shown, for example, in response to an input from an occupant in another seat (e.g., the seat 108 of FIGS. 1 to 4) or based on an input from a sensor of the vehicle (not shown). In this example, the seating surface 530 opposes the surface 228 of the base 110, the seating surface 534 opposes the surface 536 of the back 114, and the surface 226 of the headrest 118 is spaced from and extends generally parallel to the seating surface 532 of the headrest 118 to form the work surface of the seat 106 in the table configuration.

In the table configuration of FIG. 8, the surface 226 and a back surface of the seating surface 532 of the headrest 118 form a work surface accessible to an occupant supported in another seat (e.g., an occupant using the seat 108 shown in FIGS. 1 to 4). The base 110 and the back 114 of the seat 106 extend vertically in the Y and Z directions and support the headrest 118 in a cantilevered fashion. The headrest 118 extends horizontally in the X and Y directions. The combination of the seating surface 532 and the surface 226 of the headrest 118 can form a thinner, larger work surface as compared with the work surface formed by the headrest that is shown in FIGS. 2 and 4.

The surface 226 and the seating surface 532 of the headrest 118 can be adjustable in length or position in an X direction as shown by the dotted-line arrow B, for example, by changing a position of the surface 226 in respect to the seating surface 532 of the headrest 118. Positional changes can be effected using hinges, pivots, rails, guides, linkages, supports, the seat guide 122, or other positioning mechanisms (not shown) based on inputs received by the controller 124, commands sent to the seat guide 122 (or other positioning mechanisms), or based on inputs received from an occupant. The surface 226 and the back of the seating surface 532 can include connectivity features (e.g., charging access) and shaped features such as one or more cupholders, shelves, movable supports, or ledges (not shown) designed to assist in retaining objects or belongings on the surface 226 and the back of the seating surface 532 while the vehicle is in motion.

In the table configuration of FIG. 8, the surface 228 of the base 110 of the seat 106 can serve as both an interior wall of the vehicle cabin 100 and as protective surface that can weather being kicked or scuffed by an occupant (not shown) of the vehicle using the surface 226 and the seating surface 532 of the headrest 118 as a work surface. Portions or entireties of the surfaces 226, 228 of the base 110 and the headrest 118 can be formed by smooth, flat or planar, solid materials, such as polymer, wood, or composite, sufficient to weather scuffs, scratches, dents, or kicks. The surface 228 of the base 110 can protect the seating surfaces 530, 534 of the base 110 and the back 114 from damage when the seat 106 is in the table configuration shown and can prevent objects from entering other portions of the vehicle cabin 100 such as storage areas (not shown) when the seat 106 is in the table configuration shown.

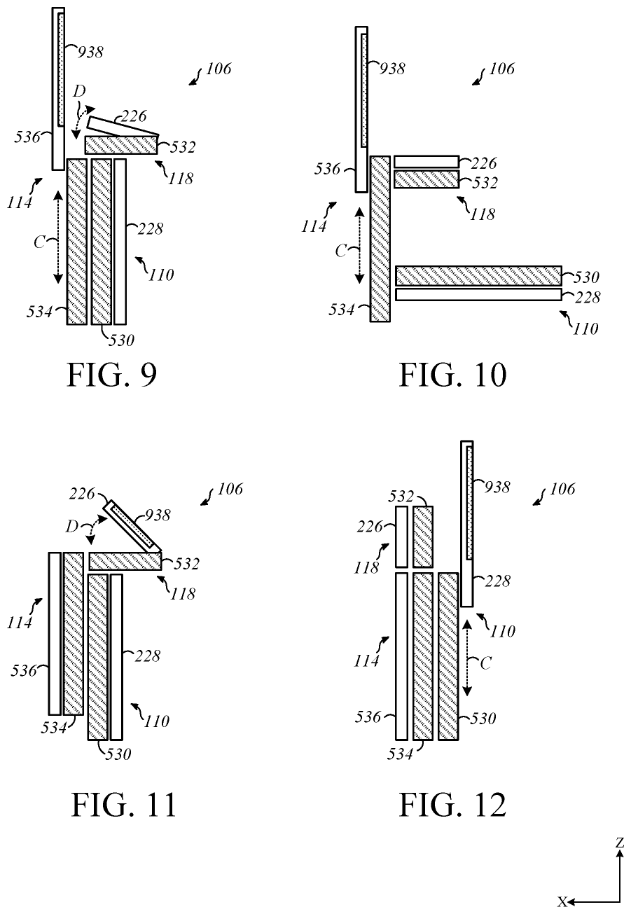

FIGS. 9 to 12 show a variety of display configurations achievable in the seating system 104 using the seat 106 of FIGS. 1 to 4 to describe the examples. Though four examples are given, additional display configurations using the seat 106 or the seats 108, 208, 306 are also possible.

FIG. 9 is a schematic side view illustration of the seat 106 of FIGS. 1 to 4 in a display configuration. The seat guide 122 and the controller 124 of FIGS. 1 to 4 can be used to move the seating surfaces 530, 532, 534 and the surfaces 226, 228, 536 between a seating configuration, a table configuration, and the shown display configuration, for example, in response to an input from an occupant in another seat (e.g., the seat 108 of FIGS. 1 to 4) or based on an input from a sensor of the vehicle (not shown).

When the seat 106 is positioned in the display configuration of FIG. 9, the surface 536 of the back 114 extends and is spaced apart in height (i.e., in the Z direction) in respect to the seating surface 534 of the back 114 as indicated by the dotted-line arrow C in order to expose a display 938 configured for viewing by an occupant in another seat in the vehicle (e.g., an occupant using the seat 108 shown in FIGS. 1 to 4). That is, the display 938 is accessible for viewing when the seat 106 is in the display configuration. The surface 536 can translate in respect to the seating surface 534 using rails, slides, tracks, electromagnets, or other positioning mechanisms (not shown). The display 938 can be sandwiched between the seating surface 534 and the surface 536, that is, inaccessible for viewing, when the seat 106 is positioned in a seating configuration or a table configuration (not shown) in order to store and protect the display 938. The display 938 can include liquid crystal components, light emitting diodes, projection components, or any other components suitable to show content to the occupant in the other seat (not sown).

When the seat 106 is positioned in the display configuration of FIG. 9, the headrest 118 extends horizontally in the X and Y directions to form a generally planar work surface. The surface 226 of the headrest 118 can also be configured to rotate in position in respect to the seating surface 532 of the headrest 118 as indicated by the dotted-line arrow D, using, for example, pivots, slots, guides, or other positioning mechanisms (not shown), to vary a position of the headrest 118 in height in the Z direction. The surface 226 of the headrest thus provides a work surface accessible to the occupant in the other seat in the vehicle (e.g., an occupant using the seat 108 shown in FIGS. 1 to 4), and this work surface is conveniently proximate to the display 938. For example, the occupant using the seat 106 in the display configuration can place a laptop, a mobile device, a keyboard, or a computing device (not shown) in a position on the surface 226 in order to closely interact with the display 938 that serves as a monitor for the laptop, the mobile device, the keyboard, or the computing device.

The seating surface 534 of the back 114 of the seat 106 extends vertically in the Y and Z directions, as does the base 110 of the seat 106. The seating surface 534 supports the display 938 associated with the surface 536 of the back 114 of the seat 106. The base 110 supports the surface 226 of the headrest 118 as a work surface in a cantilevered fashion. The surfaces 226, 536 can include connectivity features (e.g., charging access) and shaped features such as one or more cupholders, shelves, movable supports, or ledges (not shown) designed to assist in retaining objects or belongings on the surfaces 226, 536 while the vehicle is in motion.

In the display configuration of FIG. 9, the surface 228 of the base 110 of the seat 106 can serve as both an interior wall of the vehicle cabin 100 and as protective surface that can weather being kicked or scuffed by an occupant (not shown) of the vehicle using the surfaces 226, 536 and the display 938 when the seat 106 is in the display configuration shown. The seating surfaces 530, 532, 534 of the base 110, the back 114, and the headrest 118 can be inaccessible for seating when the seat 106 is positioned in the display configuration. Portions or entireties of the surfaces 226, 228, 536 of the base 110, the back 114, and the headrest 118 can be formed by smooth, flat or planar, solid materials, such as polymer, wood, or composite, sufficient to weather scuffs, scratches, dents, or kicks. The surface 228 of the base 110 can also protect the seating surfaces 530, 534 of the seat 106 from damage when the seat 106 is in the display configuration shown.

FIG. 10 is a schematic side view illustration of the seat 106 of FIGS. 1 to 4 in another display configuration. The seat guide 122 and the controller 124 of FIGS. 1 to 4 can be used to move the seating surfaces 530, 532, 534 and the surfaces 226, 228, 536 between a seating configuration, a table configuration, and the shown display configuration, for example, in response to an input from an occupant in another seat (e.g., the seat 108 of FIGS. 1 to 4) or based on an input from a sensor of the vehicle (not shown).

When the seat 106 is positioned in the display configuration of FIG. 10, the surface 536 of the back 114 is spaced apart in height (i.e., in the Z direction) in respect to the seating surface 534 of the back 114 as indicated by the dotted-line arrow C in order to expose the display 938 to an occupant in another seat in the vehicle (e.g., an occupant using the seat 108 shown in FIGS. 1 to 4) such that the display 938 is accessible for viewing. The surface 536 can translate in respect to the seating surface 534 using rails, slides, tracks, electromagnets, or other positioning mechanisms (not shown). The display 938 can be sandwiched between the seating surface 534 and the surface 536 when the seat 106 is positioned in a seating configuration or another table configuration (not shown) in order to store and protect the display 938 such that the display 938 is inaccessible for viewing.

When the seat 106 is positioned in the display configuration of FIG. 10, the headrest 118 extends horizontally in the X and Y directions to provide a work surface accessible to an occupant in another seat in the vehicle (e.g., an occupant using the seat 108 shown in FIGS. 1 to 4), and this work surface is conveniently proximate to the display 938. For example, the occupant using the work surface can place a laptop, a mobile device, a keyboard, or a computing device (not shown) on the surface 226 in order to closely interact with the display 938 when the display 938 serves as a monitor for the laptop, the mobile device, the keyboard, or the computing device.

The seating surface 534 of the back 114 of the seat 106 extends vertically in the Y and Z directions. The seating surface 534 supports the display 938 associated with the surface 536 of the back 114 of the seat 106 and supports the surface 226 of the headrest 118 as a work surface in a cantilevered fashion. The surfaces 226, 536 can include connectivity features (e.g., charging access) and shaped features such as one or more cupholders, shelves, movable supports, or ledges (not shown) designed to assist in retaining objects or belongings on the surfaces 226, 536 while the vehicle is in motion.

In the display configuration of FIG. 10, the seating surface 530 of the base 110 of the seat 106 can serve as an ottoman or footrest configured to receive feet of an occupant in another seat (e.g., an occupant using the seat 108 shown in FIGS. 1 to 4) in order to provide a more comfortable viewing experience to the occupant. Portions or entireties of the surfaces 226, 536 of the back 114 and the headrest 118 can be formed by smooth, flat or planar, solid materials, such as polymer, wood, or composite, sufficient to weather scuffs, scratches, dents, or kicks.

FIG. 11 is a schematic side view illustration of the seat 106 of FIGS. 1 to 4 in another display configuration. The seat guide 122 and the controller 124 of FIGS. 1 to 4 can be used to move the seating surfaces 530, 532, 534 and the surfaces 226, 228, 536 between a seating configuration, a table configuration, and the shown display configuration, for example, in response to an input from an occupant in another seat (e.g., the seat 108 of FIGS. 1 to 4) or based on an input from a sensor of the vehicle (not shown).

When the seat 106 is positioned in the display configuration of FIG. 11, the headrest 118 extends horizontally in the X and Y directions. The surface 226 of the headrest 118 can include the display 936 and can be configured to rotate in position in respect to the seating surface 532 as indicated by the dotted-line arrow D, using, for example, pivots, slots, guides, or other positioning mechanisms (not shown). The surface 226 of the headrest thus provides a both the display 938 that is accessible for viewing and a work surface accessible to an occupant in another seat in the vehicle (e.g., an occupant using the seat 108 shown in FIGS. 1 to 4). For example, the occupant using the work surface can place a laptop, a mobile device, a keyboard, or a computing device (not shown) in a position on the surface 226 in order to interact with the display 938.

The back 114 of the seat 106 and the base 110 of the seat support the surface 226 of the headrest 118 as a work surface in a cantilevered fashion. The surface 226 can include connectivity features (e.g., charging access) and shaped features such as one or more cupholders, shelves, movable supports, or ledges (not shown) designed to assist in retaining belongings on the surface 226 while the vehicle is in motion.

In the display configuration of FIG. 11, the surface 228 of the base 110 of the seat 106 can serve as both an interior wall of the vehicle cabin 100 and as protective surface that can weather being kicked or scuffed by an occupant (not shown) of the vehicle using the surface 226 and the display 938 of the headrest 118. The seating surfaces 530, 532, 534 of the base 110, the back 114, and the headrest 118 can be inaccessible for seating when the seat 106 is positioned in the display configuration. Portions or entireties of the surfaces 226, 228 of the base 110 and the headrest 118 can be formed by smooth, flat or planar, solid materials, such as polymer, wood, or composite, sufficient to weather scuffs, scratches, dents, or kicks. The surface 228 of the base 110 can also protect the seating surfaces 530, 534 of the seat 106 from damage when the seat 106 is in the display configuration shown.

FIG. 12 is a schematic side view illustration of the seat 106 of FIGS. 1 to 4 in a display configuration. The seat guide 122 and the controller 124 of FIGS. 1 to 4 can be used to move the seating surfaces 530, 532, 534 and the surfaces 226, 228, 536 between a seating configuration, a table configuration, and the shown display configuration, for example, in response to an input from an occupant in another seat (e.g., the seat 108 of FIGS. 1 to 4) or based on an input from a sensor of the vehicle (not shown).

When the seat 106 is positioned in the display configuration of FIG. 12, the surface 228 of the base 110 is spaced apart in height (i.e., in the Z direction) in respect to the seating surface 530 of the base 110 as indicated by the dotted-line arrow C in order to present the display 938 in a manner that is accessible for viewing by an occupant in another seat in the vehicle (e.g., an occupant using the seat 108 shown in FIGS. 1 to 4). The surface 228 can translate in respect to the seating surface 530 using rails, slides, tracks, electromagnets, or other positioning mechanisms (not shown).

When the seat 106 is positioned in the display configuration of FIG. 12, the seating surface 530 of the base 110, the back 114, and the headrest 118 of the seat 106 extend vertically in the Y and Z directions. The seating surface 530 supports the display 938 associated with the surface 228 of the base 110 of the seat 106. The surface 228 can include connectivity features (e.g., charging access) and shaped features such as one or more cupholders, shelves, movable supports, or ledges (not shown) designed to assist in retaining objects or belongings on the surface 228 while the vehicle is in motion. The seating surface 530 of the base 110 of the seat 106 can also serve as an interior wall of the vehicle cabin 100. A portion or an entirety of the surface 228 of the base 110 can be formed by smooth, flat, solid materials, such as polymer, wood, or composite, sufficient to weather scuffs, scratches, dents, or kicks.

FIG. 13 is a schematic top view illustration of an example of features of the surface 226 of the headrest 118 of the seat 106 of FIGS. 1 to 12. The surface 226 includes a cupholder 1340 configured to retain a drink or a food container. The surface 226 also includes a charging pad 1342, for example, embedded beneath an outer surface of the surface 226 as indicated in dotted lines. The charging pad 1342 is configured to charge a user device (not shown) using the surface 226, for example, when the user sets the device proximate to or on top of the charging pad 1342.

The surface 226 also includes a support 1344. The support 1344 is shown as foldable or positionable at various angles using the dotted-line arrow D. The dotted-line outline of the support 1344 is included to represent a footprint of the support 1344 when flat. The support 1344 can be used to position a device for use, such as angling a mobile device (not shown) to allow an occupant in another seat (such as the seat 108 of FIGS. 1 to 4) to view and listen to content through a display and speakers of the mobile device. In another example, the support 1344 can position a book or magazine for easier reading access by the occupant in the other seat. In another example, the charging pad 1342 can be integrated into the support 1344.

The surface 226 can be surrounded by a ledge 1346 designed to assist in retaining objects or belongings on the work surface of the headrest 118 while the vehicle cabin 100 in is motion. The ledge 1346 can surround two, three (as shown), or four sides of the surface 226 to serve the retention purpose, for example, to stop objects from sliding off the surface 226 when the vehicle cabin 100 is in motion. The ledge 1346 can be absent in other examples.

FIG. 14 is a schematic front view illustration of the surface 536 including the display 938 of the seat 106 as shown in FIGS. 9, 10, and 12. The surface 536 includes access ports 1448, for example, allowing connection between external devices (not shown) and the display 938 or other portions of the vehicle cabin 100. The access ports 1448 can support data transfer, charging, or other communication features.

The surface 536 includes a shelf or a ledge 1450. The ledge 1450 can be used to position objects proximate to the display 938 or proximate to the access ports 1448, for example, to allow charging a mobile device (not shown) or to allow wirelessly transmitting content from the mobile device to the display 938. The surface 536 can support additional features (not shown) such as audio components, charging components, or retention components suitable to keep objects attached to the surface 536 while the vehicle cabin 100 is in motion.

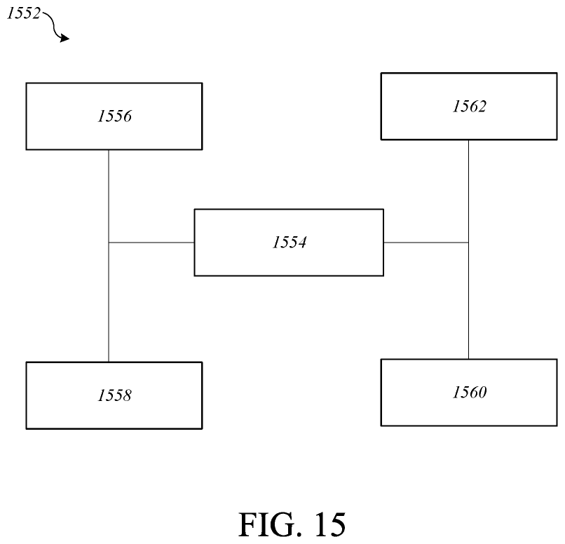

FIG. 15 is a block diagram that shows a seating system 1552. The seating system 1552 can include a controller 1554, sensors 1556, seats 1558, a seat guide 1560, and a user interface 1562. The seating system 1552 can include components similar to components described in reference to the seating system 104 of FIGS. 1 to 14.

The controller 1554 can operate in a manner similar to the controller 124 described in reference to FIGS. 1 to 4. The seats 1558 can operate in a manner similar to the seats 106, 108, 208, 306 described in reference to FIGS. 1 to 12. The seat guide 1560 can operate in a manner similar to the seat guide 122 described in reference to FIGS. 1 to 4. The seating system 1552 is shown as including the sensors 1556, the seat guide 1560, and the user interface 1562, but one or more of these components may be absent from the seating system 1552.

The controller 1554 coordinates operation of the seating system 1552 by communicating electronically (e.g., using wired or wireless communications) with the sensors 1556, the seats 1558, the seat guide 1560, and the user interface 1562. The controller 1554 may receive information (e.g., signals, information, and/or data) from the sensors 1556 and may receive information from and/or send information to other portions of the seating system 1552 such as the seats 1558, the seat guide 1560, the user interface 1562, or other portions (not shown).

The sensors 1556 can capture or receive information related, for example, to components of the seating system 1552 and from an external environment where the seating system 1552 is located. The external environment can be an exterior of a vehicle or an interior of a vehicle such as the vehicle cabin 100 of FIGS. 1 to 4. Information captured or received by the sensors 1556 can relate to portions or entireties of the seats 1558, occupants, operation of other vehicles, pedestrians and/or objects in the external environment, operating conditions of the vehicle, operating conditions or trajectories of other vehicles, and/or other conditions within the vehicle or exterior to the vehicle.

The seat guide 1560 can be configured to control or enable movement of the seats 1558, either in entireties or portions thereof, using hinges, linkages, pivots, rails, guides, slots, tracks, motors, actuators, electromagnets, or any other suitable mechanisms (not shown) to support motion such as translation and rotation. The seat guide 1560 can be used to change a configuration of the seats 1558 based on a control signal, such as a signal from the controller 1554 based on inputs to the user interface 1562. The control signal may be based on information captured or received by the sensors 1556 and may cause various portions of the seats 1558, such as the seating surfaces 530, 532, 534 and the surfaces 226, 228, 536 of the seat 106 shown in FIGS. 1 to 14, to change between various operational modes, such as between a seating configuration, a table configuration, and a display configuration.

The user interface 1562 can take various forms, such as an application that receives user inputs through a mobile device, a button, or an input mechanism that receives voice commands from a user of the seating system 1552.

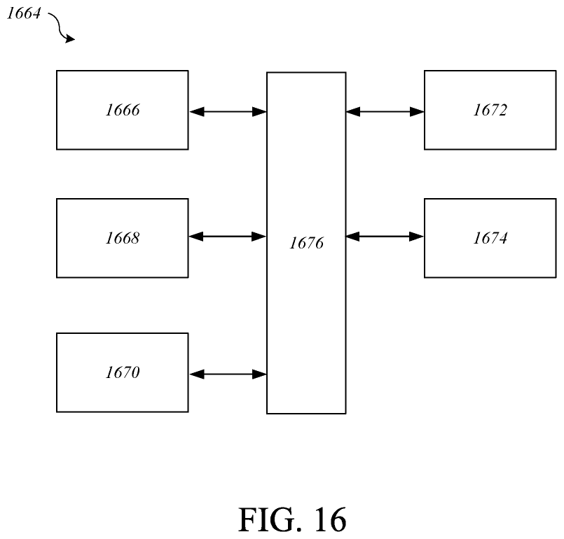

FIG. 16 shows an example of a hardware configuration for a controller 1664 that may be used to implement the controller 1554 and/or other portions of the seating system 1552. In the illustrated example, the controller 1664 includes a processor 1666, a memory device 1668, a storage device 1670, one or more input devices 1672, and one or more output devices 1674. These components may be interconnected by hardware such as a bus 1676 that allows communication between the components.

The processor 1666 may be a conventional device such as a central processing unit and is operable to execute computer program instructions and perform operations described by the computer program instructions. The memory device 1668 may be a volatile, high-speed, short-term information storage device such as a random-access memory module. The storage device 1670 may be a non-volatile information storage device such as a hard drive or a solid-state drive.

The input devices 1672 may include sensors such as the sensors 1556 and/or any type of human-machine interface, such as buttons, switches, a keyboard, a mouse, a touchscreen input device, a gestural input device, or an audio input device. The output devices 1674 may include any type of device operable to send commands associated with an operating mode or state or provide an indication to a user regarding an operating mode, state, or configuration, such as a display screen including the display 938, an interface for a seating system such as the seating systems 104, 1552, or an audio output.

Various seating systems and methods described here may use personal information to identify a location of or determine an identification of a user. User experience can be improved by such use of personal information. Any use or collection of personal information is with consent of the user and for valid purposes. Security protocols, privacy practices, and jurisdictional rules direct handling of personal information. Use of personal information by the various seating systems and methods described here may be at the discretion of the user, and the various seating systems and methods described here are functional without the use of personal information.

What is claimed is:

1. A seating system for a vehicle, comprising:
a seat, comprising:
a base;
a back; and
a headrest; and
a seat guide configured to move the seat from a seating configuration to a table configuration,
wherein one or more surfaces of the base, the back, or the headrest form a height-extendible work surface in the table configuration.

2. The seating system of claim 1, wherein the one or more surfaces that form the work surface include a planar portion that extends in a horizontal manner to support objects when the seat is positioned in the table configuration.

3. The seating system of claim 2, wherein first surfaces of the base, the back, and the headrest are seating surfaces when the seat is positioned in the seating configuration, wherein one or more second surfaces of the base, the back, and the headrest include the work surface, and wherein the first surfaces face in a different direction than the respective second surfaces.

4. The seating system of claim 3, wherein the first surfaces of the base, the back, and the headrest oppose the respective second surfaces of the base, the back, and the headrest when the seat is positioned in the table configuration and the seating configuration.

5. The seating system of claim 3, wherein the seating surface of the back forms an interior surface of a vehicle cabin of the vehicle when the seat is positioned in the table configuration.

6. The seating system of claim 3, wherein the second surfaces of the back and the headrest form the work surface when the seat is positioned in the table configuration.

7. The seating system of claim 3, wherein the second surface of the base forms an interior surface of a vehicle cabin of the vehicle when the seat is positioned in the table configuration.

8. The seating system of claim 3, wherein the second surface of the base forms the work surface when the seat is positioned in the table configuration.

9. A seat, comprising:
a base;
a back;
a headrest; and
a display integrated into one or more surfaces of the base, the back, or the headrest,
wherein the display is inaccessible for viewing when the seat is positioned in a seating configuration and is accessible for viewing when the seat is positioned in in a display configuration.

10. The seat of claim 9, wherein the base, the back, and the headrest include first surfaces that are seating surfaces and different, opposed second surfaces that face away from the respective first surfaces when the seat is positioned in the seating configuration.

11. The seat of claim 10, wherein the display is sandwiched between respective first and second surfaces of the base or the back when the seat is positioned in the seating configuration.

12. The seat of claim 9, further comprising:
a seat guide configured to move the seat from the seating configuration to the display configuration.

13. The seat of claim 12, wherein movement between the display configuration and the seating configuration using the seat guide occurs responsive to receiving a command, from a controller, based on an input from an occupant or based on an input from a sensor.

14. The seat of claim 9, wherein one or more of the surfaces of the base, the back, or the headrest that do not include the display form a work surface that includes a planar portion that extends in a horizontal manner to support objects when the seat is positioned in the display configuration.

15. The seat of claim 14, wherein the work surface includes a cupholder, a shelf, a ledge, or a support.

16. A seating system for a vehicle, comprising:
a seat, comprising:
a base and a back, wherein seating surfaces of the base and the back are configured to support an occupant in the seat when the seat is positioned in a seating configuration;
a display integrated into one or more of the base or the back, the display accessible for viewing when the seat is positioned in a display configuration and inaccessible for viewing when the seat is positioned in the seating configuration; and
a work surface integrated into one or more of the base or the back, the work surface accessible to support objects when the seat is positioned in the display configuration and inaccessible to support objects when the seat is positioned in the seating configuration; and
a seat guide configured to move the seat from the seating configuration to the display configuration.

17. The seating system of claim 16, wherein the seating surfaces of the base and the back are inaccessible for seating when the seat is positioned in in the display configuration.

18. The seating system of claim 16, wherein the one or more of the base or the back that includes the display extends to a height that is adjustable for access when the seat is positioned in the display configuration.

19. The seating system of claim 16, wherein the seating surfaces of the base and the back oppose respective surfaces of the base and the back that include the display or the work surface when the seat is positioned in the seating configuration.

20. The seating system of claim 16, wherein the seating surface of the base or the back forms an ottoman configured to receive feet of another occupant when the seat is positioned in the display configuration.
